(19) United States
(12) Patent Application Publication
(10) Pub. No.: US 2008/0026833 A1
(43) Pub. Date: Jan. 31, 2008

(54) GAMING MACHINE AND GAMING METHOD THEREOF

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORPORATION, Tokyo (JP)

(21) Appl. No.: 11/828,668

(22) Filed: Jul. 26, 2007

(30) Foreign Application Priority Data
Jul. 26, 2006 (JP) 2006-203494

(51) Int. Cl. A63F 13/00; A63F 13/02; A63F 13/10

(52) U.S. Cl. 463/26; 463/31; 463/43

(57) ABSTRACT

A gaming environment having plural jackpots in which plural jackpot value storages arranged is described. When a bet operation is conducted, one or more jackpots to be accumulated a portion of a bet value may be selected among the plural jackpots based on a predetermined rule, and then the bet value may be accumulatively stored in jackpot value storages corresponding to selected the one or more jackpots. When a condition is satisfied, an outcome corresponding to one or more accumulated jackpot values stored in one or more selected jackpot value storages may be provided.

### CROSS-REFERENCE TO RELATED APPLICATIONS

This application is based upon and claims a priority from the prior Japanese Patent Application No. 2006-203494 filed on Jul. 26, 2006, the entire contents of which are incorporated herein by reference.

### BACKGROUND

1. Field

One or more aspects of the present invention related to a gaming machine, gaming method thereof, and a game system that have so-called progressive bonus which accumulatively store a part of bet value of gaming medium in storages, and in particular, one or more aspects of the present invention related to a gaming machine, gaming method thereof, and a game system that have plural storages and accumulatively store the value in only selected storage.

2. Description of Related Art

In gaming machines using medals such as the gaming medium, such as slot machines, roulette game machines, bingo game machines, horse racing machines, or the like, a player buys or rents plural medals at medal lending machines. The game is started in response to the medal being input to the gaming machine. If the player wins the game, predetermined number of medals will be provided to the player. Accordingly, the more the player obtains the medals, the more the player can play the game without buying or renting more medals. In recent years, in the gaming machines which include the progressive game are popular for the enhancement of the player's interest. In the progressive bonus of the slot machines, predetermined portion of the value of bet medals which is bet by the player, is accumulated in the jackpot every game, and when predetermined condition is met, outcome corresponding to accumulated bet value will be provided at once. Thereby, the player can obtain higher payout that is difficult to obtain in the base game.

Heretofore, some slot machines have plural jackpots. A predetermined portion of the value of bet count every game of each gaming machine is accumulated in first jackpot value storage area and second jackpot value storage area. When predetermined condition is met, a jackpot game is occurred. In the jackpot game, if first predetermined condition or second predetermined condition is met, outcome (for example, medals) corresponding to the accumulated value stored in the first jackpot value storage area or the second jackpot value storage area will be provided. In the gaming machine having plural jackpot value storage areas, even though the player win one of the jackpot, accumulated jackpot value stored in another jackpot storage will not decrease. Accordingly, the player can have expectation that another jackpot will be won even if the jackpot is won just a short while ago, and the player may play the game for a longer time.

In the above conventional examples, when bet operation is conducted by the player, predetermined portion of the value of the bet count is always accumulated in each of the jackpot value storage areas. Here, each of the jackpot values is accumulated almost equally. Here, because of the player's expectation, the player may want to understand the jackpot amount frequently.

### SUMMARY

In view of the foregoing, one or more aspects of the present invention relate to a gaming machine, a gaming method thereof, a game system, a computer readable medium having computer-executable instructions or the like that have plural jackpots. Also, in one or more aspects of the present invention, a gaming machine selects one or more memory devices among plural memory devices based on a predetermined rule and accumulatively stores a portion of the bet value in the one or more selected memory devices, and selects one or more memory devices among the plural memory devices and provides an outcome corresponding to an accumulated value stored in the one or more memory devices in response to a condition being satisfied. Also, in one or more aspects, the gaming machine displays images in which each of the images being associated with the memory device and the accumulated value stored in the memory device. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a block diagram showing a control system of a server in the first illustrative embodiment in accordance with one or more aspects of the present invention.

FIG. 2 is a perspective view showing a game system in the first illustrative embodiment in accordance with one or more aspects of the present invention.

FIG. 3 is a perspective view showing a slot machine in the first illustrative embodiment in accordance with one or more aspects of the present invention.

FIG. 4 is a view schematically showing symbol rows displayed on each of outer surfaces of each reel in accordance with aspects of the present invention.

FIG. 5 is a block diagram showing a control system of the slot machine in the first illustrative embodiment in accordance with one or more aspects of the present invention.

FIG. 6 is a view showing a payout table of the slot machine which indicates winning combinations, probabilities thereof, and payout numbers thereof in the first illustrative embodiment in accordance with one or more aspects of the present invention.

FIG. 7 is a view showing a bonus game lottery table of the game system in the first embodiment in accordance with one or more aspects of the present invention.

FIG. 8 is a view showing an accumulation object selection table of the game system in the first embodiment in accordance with one or more aspects of the present invention.

FIG. 9 is a flowchart of a main control process program of the slot machine in the first illustrative embodiment in accordance with one or more aspects of the present invention.

FIG. 10 is flowcharts of a main game process program of the slot machine and a jackpot accumulation process of a server in the first illustrative embodiment in accordance with one or more aspects of the present invention.

FIG. 11 is flowcharts of a bonus game process program of the slot machine and a bonus game jackpot value update process of a server in the first illustrative embodiment in accordance with one or more aspects of the present invention.

FIG. 12 is a view showing a jackpot value display image displayed on a main display of the game system in the first illustrative embodiment in accordance with one or more aspects of the present invention.

FIG. 13 is a view showing a list of the fish images to be displayed on the jackpot value display image in the first illustrative embodiment in accordance with one or more aspects of the present invention.

FIG. 14 is a view showing the jackpot value display image in case of the jackpot value being accumulated in accordance with aspects of the present invention.

FIG. 15 is a view showing a bonus game image displayed on a lower image display panel of the slot machine in accordance with aspects of the present invention.

FIG. 16 is a view showing the bonus game image with the payout being displayed in accordance with aspects of the present invention.

FIG. 17 is a view showing a list of the fish images to be displayed on the jackpot value display image in the second illustrative embodiment in accordance with one or more aspects of the present invention.

FIG. 18 is flowcharts of a main game process program of the slot machine in the third illustrative embodiment in accordance with one or more aspects of the present invention.

FIG. 19 is flowcharts of a bonus game process program of the slot machine in the third illustrative embodiment in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD), computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Some embodiments (a first embodiment to a third embodiment, for instance) embodying one or more aspects of the invention as a game system 3 will be described in detail with reference to the drawings below. Here, the game system 3 may be constructed from plural slot machines 1 and a server 2. Here, in the slot machine 1 and the game system 3, three jackpots may be set. Also, three jackpot value storage areas (first jackpot value storage area to third jackpot value storage area) are arranged. Here, the number of jackpots is variable. Also, the number of the jackpot value storage areas is variable. The portion of the value of bet count will be stored in the jackpot value storage area. Each of the jackpot value storage areas corresponds to each of the jackpot. When the bet operation is conducted with the credit input, the jackpot value storage area to be accumulated may be selected among the first jackpot value storage area to the third jackpot value storage area, and then the portion of the value of the bet count will be accumulatively stored in the selected jackpot value storage area.

### First Embodiment

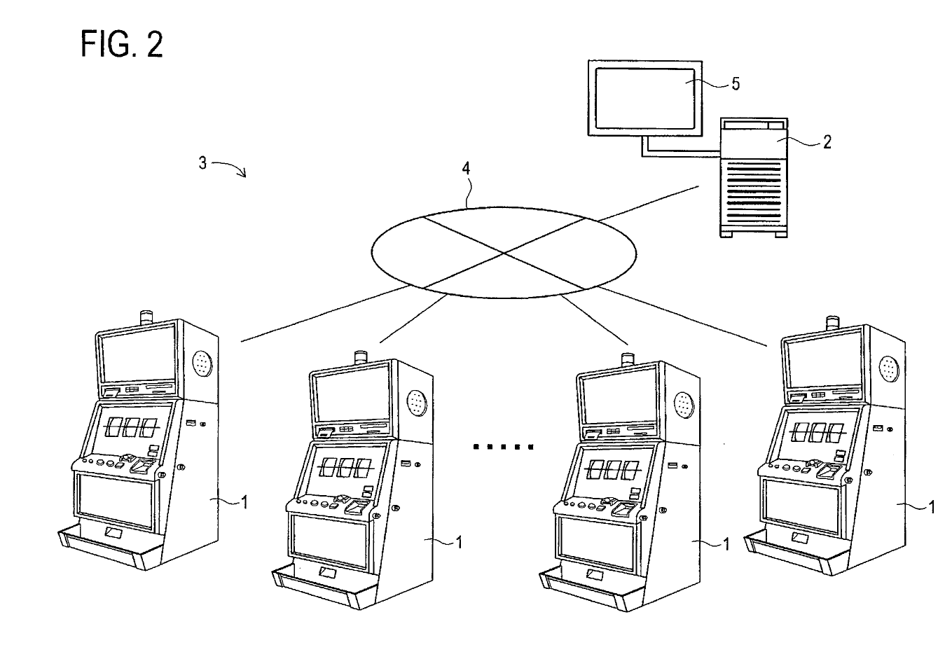

At first, a construction of a gaming system 3 of the first embodiment embodying one or more aspects of the invention will be described with reference to FIG. 2. As shown in FIG. 2, the game system 3 may be constructed from plural slot machines 1 located in game hall, a server 2 located in the same game hall, and network 4 (communication line or other communication pathway). The slot machines 1 may communicate with the server 2 via the network 4. The server 2 may communicate with the slot machines 1 via the network 4. A construction of the slot machines 1 will be described in detail later.

The network 4 may be constructed from two-way communicative line such as LAN (Local Area Network). The slot machine 1 and the server 2 send and receive various data related to the game across the network 4 each other. For example, if the bet is operated in the slot machine 1, the bet information will be sent to the server 2 (which will be described later). Also, if the jackpot is won, information of jackpot value accumulated until now will be sent to the slot machine 1.

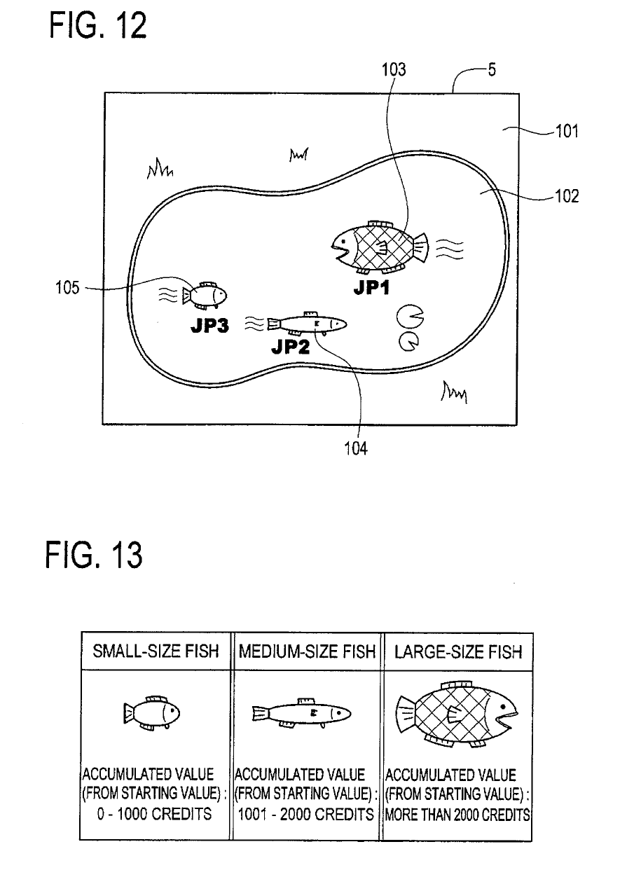

The server 2 may include a main display 5. The main display 5 may be arranged where all players can look it. The server 2 of the first embodiment may include three different jackpot storage areas. Three jackpot values (first jackpot value, second jackpot value, and third jackpot value) may be stored in the three storage areas respectively. Here, the number of the jackpot and the jackpot value storage areas are variable. Three fish images corresponding to each of the accumulated jackpot values which indirectly inform the jackpot value may be displayed on the main display 5 (see FIG. 12). Here, the character of images displayed on the main display 5 is variable. The image displayed on the main display 5 may include animal.

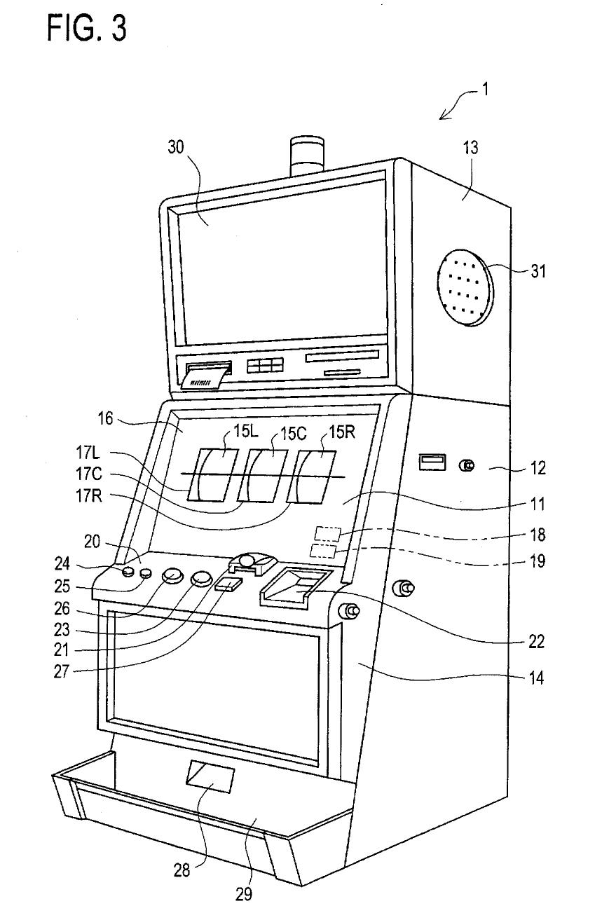

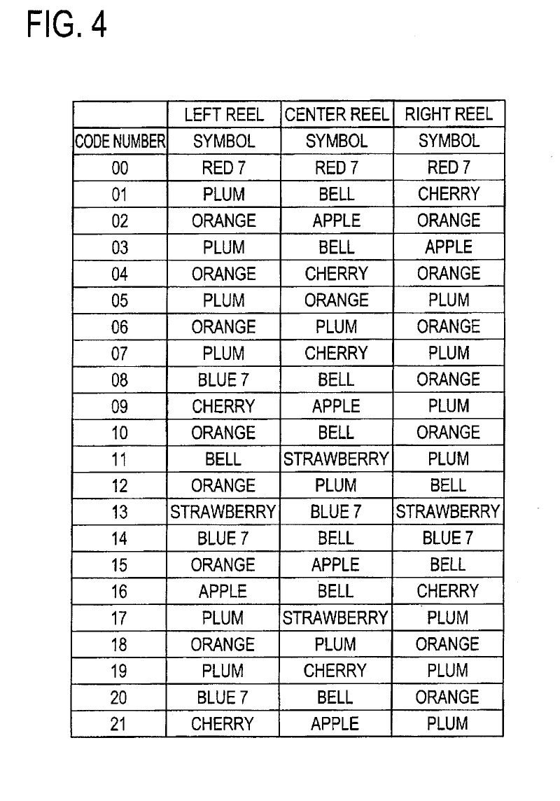

Next, a construction of a slot machine 1 of the first embodiment embodying one or more aspects of the invention will be described with reference to FIG. 3. FIG. 3 is a perspective view showing the slot machine of the first embodiment. The slot machine 1 may include a cabinet 12, a top box 13, and a main door 14. The top box 13 may be arranged on the cabinet 12 (for instance, arranged on upper side). The main door 14 may be arranged at front of the cabinet 12. Three reels 15L, 15C, and 15R are arranged inside the cabinet 12. The three reels may spin. Some symbols (for example, twenty two symbols) may be displayed on outer surface of each of the reels 15L, 15C, and 15R (see FIG. 4). Here, the number of reels is variable (including but not limited to four or five). Here, the reels may be constructed from image data (namely, the virtual reels displayed on the monitor).

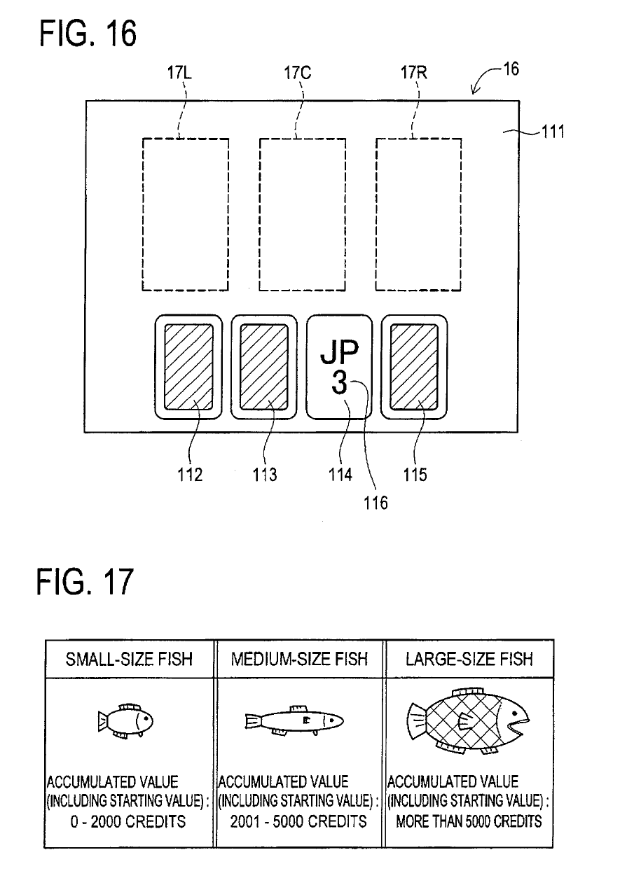

A lower image display panel 16 may be arranged on the main door 14, namely at the front of the each of the reels 15L, 15C, and 15R. The lower image display panel 16 may be constructed, for instance, from well-known transparent liquid crystal panel. Here, the lower image display may be CRTs, liquid crystal displays, plasma displays, LED displays, OLED displays, and other known display technologies. The symbols displayed on each of the reels 15L, 15C, and 15R are visible through display windows 17L, 17C, and 17R in the base game. In the bonus game, each of the reels 15L, 15C, and 15R is invisible. Because predetermined bonus display (see FIG. 15 and FIG. 16) may be displayed on the lower image display panel 16. A touch panel 11 may be arranged at the front of the lower image display panel 16, and the player can input various instructions by operating the touch panel 11. Also, the touch panel 11 may be used when the player selects selection item such as card images displayed on the lower image display panel 16 in the bonus game (which will be described later).

A credit count display portion 18 and a payout number display portion 19 are arranged on the lower image display panel 16. The credit count in which the player currently owns may be displayed on the credit count display portion 18. The payout number, which indicates the payout number, which will be provided when a combination of stopped and displayed symbols on payline(s) L, is any of predetermined combinations or will be acquired in the bonus game, may be displayed on the payout number display portion 19.

The display windows 17L, 17C, and 17R are formed at the lower image display panel 16. Each of three symbols displayed on each of outer surfaces of each reel 15L, 15C, and 15R may be visible through each of the display windows 17L, 17C, and 17R. Here, if the reels are image data (namely, the virtual reels displayed on the lower image display), the windows 17L, 17C, and 17R may be displayed on the lower image display panel 16 (namely, the windows 17L, 17c, and 17R may be variably display portions). The payline L may cross three display windows 17L, 17C, 17R (for example, horizontally). The payline(s) L may set the combination of the symbols. If the combination of stopped and displayed symbols is predetermined combination, the payout number will be provided based on the combination and the number of bet credit (referred to herein as the “bet count”).

A control panel 20 may be arranged at the image display panel 16 (for example, arranged on lower side). Buttons are arranged at the control panel 20. The buttons are the buttons to input the instructions for gaming session by the player. A coin insertion slot 21 and a bill verifier 22 can be arranged in relation to the image display panel 16 (for example, arranged on lower side). The coin insertion slot 21 may receive the gaming medium into the cabinet 12. A spin button 23, a change button 24, a cash out button 25, a 1-bet button 26, and a max-bet button 27 may be arranged on the control panel 20. The spin button 23 can be used when the instruction for the start for the reels 15L, 15C, and 15R spin is input. Here, a physical lever may be used as substitute for the spin button 23. Also, the physical lever may be used in conjunction with the spin button 23. The change button 24 is used when the exchange is required. The cash out button 25 is the instruction for the payment of the coin (for example, one credit is equal to one coin) or for the print a ticket. One or more bar codes may be printed in the ticket. The ticket may be called GAMING VOUCHER. The coin may be paid through a coin payout opening 28 to a coin tray 29. Here, other than bar code may be used as substitute for the bar code (for example, QR Code (two-dimensional bar code)). The 1-bet button 26 is used when the instruction for the bet to one credit from the player's credits. The max-bet button 27 is used when the instruction for the bet to available maximum bet count in one game (for example, fifty credits) from the credits which is owned by the player is input. Here, 3-bet button or the like may or may not be arranged.

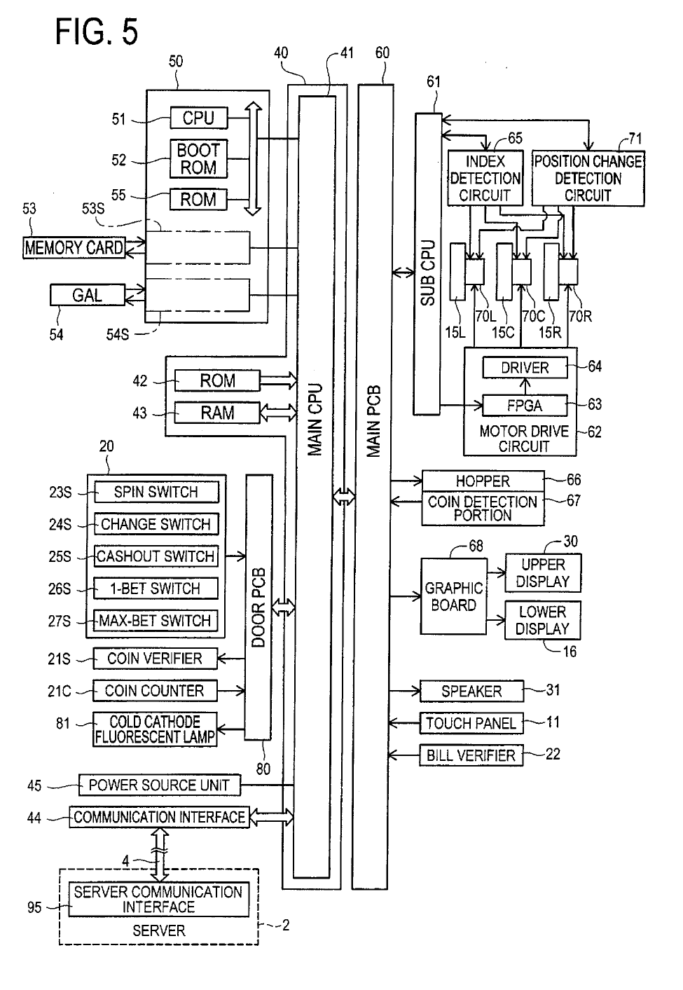

A coin verifier 21S and a coin counter 21C (see FIG. 5) are arranged inside of the coin insertion slot 21. The coin verifier 21S verifies the coin inserted from the coin insertion slot 21, and the fake coins may be discharged through the coin payout opening 28. The coin counter 21C detects qualified coin and counts the number of the coins.

The bill verifier 22 verifies the bill and receives qualified bill into cabinet 12. The bill which is received into cabinet 12 is converted to the coin count, and the credit count corresponding to the converted coin count may be added to the owned credit count of the player. The bill verifier 22 can read a ticket.

In the slot machine 1 of the first embodiment, the gaming medium may be coin, bill, or electronic value (credit). Here, the gaming medium may be other things as well (including but not limited to medal, token, electronic money, or ticket).

An upper image display panel 30 may be arranged with the slot machine 1 (for example, arranged in front of the top box 13). The upper image display panel 30 may include the display device (for example, LCD panel). Gaming information such as the first jackpot value to the third jackpot value and the instructions for the game may be displayed on the upper image display panel 30. A loud speaker 31 may be arranged with respect to the slot machine 1 (for example, arranged side of the top box 13).

The symbols displayed on each of outer surfaces of the reels 15L, 15C, and 15R will be described with reference to FIG. 4. The symbols may be variably displayed while being scrolled in the game in one or more aspect of the invention. The symbols are visible through the display windows 17L, 17C, and 17R of the lower image display panel 16. FIG. 4 is a view schematically showing the symbol rows displayed on each of outer surfaces of each reel 15L, 15C, and 15R.

Some symbols (for example, twenty-two symbols) are displayed on each of outer surfaces on the left reel 15L, the center reel 15C, and the right reel 15R. Here, the number of symbols is variable. The symbols may include “RED7”, “BLUE7”, “BELL”, “CHERRY”, “STRAWBERRY”, “PLUM”, “ORANGE”, and “APPLE”. Here, the kinds of symbols are variable. The symbols may be displayed each reel 15L, 15C, and 15R in predetermined order, as shown in FIG. 4. Here, the order is variable.

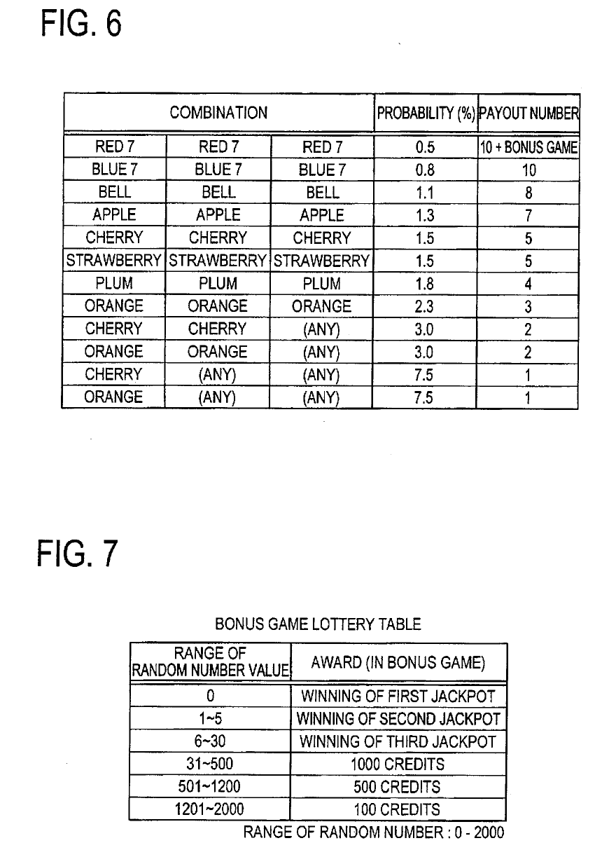

If three “BLUE7” symbols, three “CHERRY” symbols, three “STRAWBERRY” symbols, three “PLUM” symbols, three “ORANGE” symbols, or three “APPLE” symbols are stopped and displayed on the payline L, predetermined payout number may be provided to the player (see FIG. 6). If one or two “CHERRY” symbols or “ORANGE” symbols are stopped and displayed on the payline L, predetermined payout number may be provided to the player based on the number of stopped symbols (see FIG. 6).

If three “RED7” symbols are stopped and displayed on the payline L, the procedure will be shifted to the bonus game in addition to that predetermined payout number will be provided to the player. Here, in the bonus game executed in the first embodiment, plural selection item images are displayed on the lower image display panel 16 and the payout number will be provided based on the player's selection. The bonus game may be such as selection-type game. Here, the bonus game in detail will be described later.

When the bet count is determined based on the operation of the 1-bet button 26 or max-bet button 27 and then the spin button 23 is operated, the reels 15L, 15C, and 15R will start to spin. Accordingly, the symbols may be variably displayed in the display windows 17L, 17C, and 17R (for example, scrolled from top to bottom). After predetermined time is elapsed, the reels 15L, 15C, and 15R will end spinning. Accordingly, the symbols will be displayed in the display windows 17L, 17C, and 17R. Here, winning combinations of the symbols are set beforehand (see FIG. 6). If the symbols which form the winning combination stop on the payline, the payout number corresponding to the winning combination thereof will be provided to the player.

A control system of the first embodiment of the slot machine I will be described with reference to FIG. 5. FIG. 5 is a block diagram schematically showing the control system of the slot machine 1 of the first embodiment.

The control system of the slot machine 1 may be constructed from a mother board 40 and a gaming board 50 as shown in FIG. 5. The gaming board 50 may be constructed from a CPU 51, a ROM 55, a boot ROM 52, a card slot 53S, and an IC socket 54S. The CPU 51, the ROM 55, and the boot ROM 62 are interconnected via internal bus. A card slot 53S is adapted to receive the memory card 53. An IC socket 54S is adapted to receive a GAL (Generic Array Logic) 54. Here, PLD (Programmable Logic Device) which is other than the GAL 54 may be substituted for the GAL 54.

The memory card 53 may be constructed from non-volatile memory. Game programs and game system programs (hereinafter, “the game program and the like”) may be stored therein. The game programs stored in the memory card may include two kinds of lottery programs (first lottery program to third lottery program). The first lottery program is a symbol lottery program. The symbol lottery program may be used so as to determine symbols of each of the reels 15L, 15C, and 15R (namely, code numbers corresponding to symbols) to be stopped and displayed on the payline L. The symbol lottery program may include three symbol weighting data table. Each of the weighting data tables corresponds to each plural payout ratios (for example, 80%, 84%, and 88%). The symbol weighting data table may indicate a relation between each of the code numbers for each symbol and predetermined range of the random number values. Each of the code numbers for each symbol corresponds to one or more random number values. Accordingly, if random number is sampled, the symbol corresponding to sampled random number value may be stopped and displayed. The second lottery program is a bonus game lottery program used when the payout to be provided to the player is determined in the bonus game. Here, the payout may include “winning of the first jackpot”, “winning of the second jackpot”, “winning of the third jackpot”, “1000 credits payout number”, “500 credits payout number”, or “100 credits payout number”. Here, the kinds of the payout are variable. Here, the predetermined portion of bet count is variable. The predetermined portion may or may not be 5%. Here, the payout ratio may be set based on the payout ratio setting data from the GAL 54. Various lotteries may be conducted based on the symbol weighting data corresponding to the payout ratio.

The card slot 53S may be constructed so that the memory card 53 is detachable, and connected to the mother board 40 via bus (for example, IDE bus). The kinds of the game and the contents of the game executed in the slot machine 1 can be changed in a case where the game program and the like stored in the memory card 53. Also, the kinds of games and the contents of the games executed in the slot machine 1 can be changed in a case where the memory card 53 is exchanged to another memory card in which another game program or the like is stored therein. The game program may include the program related to the gaming session, the image data and sound data as output during the gaming session, and notification data such as the image data or sound data.

The GAL 54 can be one of the PLD, which may contains a fixed OR array. The GAL 54 has plural input ports and output ports. If predetermined data is input to the input port(s), the data corresponding thereto will output to the output port(s). The output data is the payout ratio setting data.

The IC socket 54S is constructed so that the GAL 54 is detachable, and connected to the mother board 40 via a bus (for example, PCI bus). The payout ratio setting data can be changed in a case where the GAL 54 is re-written or is exchanged.

The CPU 51, the ROM 55, and the boot ROM 52 may be connected to the mother board 40 via the PCI bus. The CPU 51, the ROM 55, and the boot ROM 52 are interconnected via internal bus. The PCI bus transmits the signal between the mother board 40 and the gaming board 50. The mother board 40 supplies the electric power to the gaming board 50. The country ID and the verification program are stored in the ROM 55. The preliminary verification program and the boot code may be stored in the boot ROM 52. The CPU 51 may boot the preliminary verification program with the use of the boot code.

The verification read program is used to verify the game program and the like. The verification program is executed to check whether or not falsification of data has been done. The verification program checks for the falsification of the game program and the like. The game program and the like will be the object of the verification read process. A preliminary verification program may or may not be used to verify the verification program. The preliminary verification program is written along the procedure for the check of falsification of the verification program. The verification program can be the subject of the verification process.

The mother board 40 will be described. The mother board 40 may be constructed from general mother board (printed circuit board which mounts basic components), and may include a main CPU 41, a ROM 42, a RAM 43, and a communication interface 44.

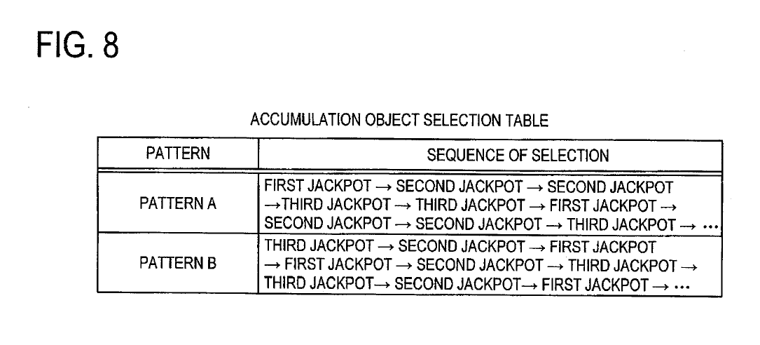

The ROM 42 may be constructed from a memory device such as the flash memory (for example). The preliminary data such as BIOS program, the payout table and lottery table in the base game and the bonus game (see FIG. 6 and FIG. 7), and the accumulation object selection table (see FIG. 8) may be stored in the ROM 42. In the accumulation object selection table, the sequence of selection for the jackpot to be accumulated may be set. BIOS program can be executed by the main CPU 41. If the BIOS is executed by the main CPU 41, the initial process for predetermined peripheral devices, and the read process for the game program and the like stored in the memory card 53 will be started via the gaming board 50.

The data and the program, which are used when the main CPU 41 runs, are stored in the RAM 43. The verification program (which will be read via the gaming board 50), various programs (such as the game program and the like), the number of the player's credits, and the number of executed games may be stored in the RAM 43.

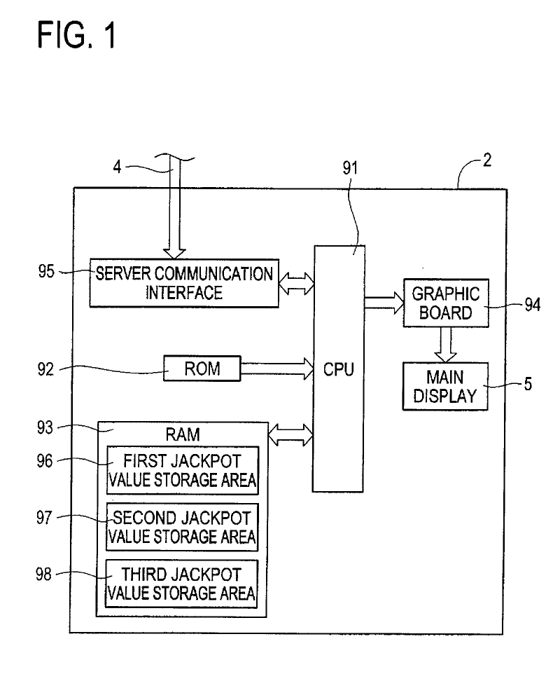

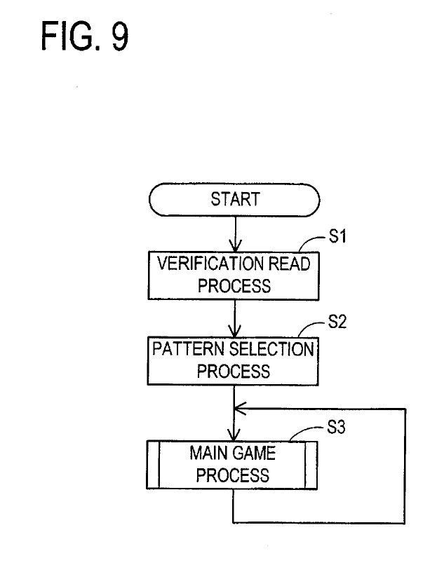

The communication interface 44 can be a communication device communicating to the server located in the game hall via the network 4. The slot machine 1 may communicate bet information in the main game process (which will be described later, see S2 of FIG. 9) and/or the random result of the lottery process with the server 2 via the network 4. Here, a control system of the server 2 will be described with reference to the FIG. 1 later.

A main PCB (Printed Circuit Board) 60 and a door PCB 80 (which will be described later) are connected to the mother board 40 respectively via USB (for example). A power source unit 45 is connected to the mother board 40. If the power source unit 45 supplies the electric power to the mother board 40, the main CPU 41 on the mother board 40 will be booted up. When the electric power is supplied to the gaming board 50, the CPU 51 will be booted up.

Some devices, which generate the input signal to the main CPU 41, are connected to the main PCB 60 and the door PCB 80. Some devices, which are control by the control signal from the main CPU 41, are connected to the main PCB 60 and the door PCB 80. The main CPU 41 executes the game program and the like stored in the RAM 43 based on the input signal which is input thereto. The CPU 41 stores the calculation result to the RAM 43 and controls some devices by executing predetermined calculation process.

A sub CPU 61, a hopper 66, a coin detection portion 67, a graphic board 68, the loudspeaker 31, a touch panel 11, and the bill verifier 22 may be connected directly or indirectly to the main PCB 60.

The touch panel 11 may be arranged in front of the lower image display panel 16. The touch panel 11 can recognize the place where the player touches the touch panel 11 based on the coordinate information of the portion touched by the player. Also, the touch panel 11 can recognize the direction where the player touches and moves based on the coordinate information of the portion touched by the player.

The sub CPU 61 controls the spin and the stop for each of the reels 15L, 15C, and 15R. FPGA (Field Programmable Gate Array) 63 and a motor drive circuit 62 are connected to the sub CPU 61. Here, PLD (Programmable Logic Device), which is other than the FPGA 63, may be substituted form the FPGA 63. The motor drive may include driver 64. The FPGA may be a programmable circuit such as a LSI. The FPGA functions as the control circuit for stepping motors 70L, 70C, and 70R. The driver 64 functions as amplifier circuit for input pulse, which will be input to the stepping motors 70L, 70C, and 70R. The stepping motors 70L, 70C, and 70R are connected to the motor drive circuit 62. The stepping motors may be such as but not limited to a half step drive. The reels 5L, 5C, and 5R are spun by the stepping motors 70L, 70C, and 70R.

An index detection circuit 65 and a position change detection circuit 71 may be connected to the sub CPU 61. The index detection circuit 65 detects the positions (for example, base point) of the reels 15L, 15C, and 15R, and detects the current position of the reels 15L, 15C, and 15R. The slot machine 1 may change the stop position of the reels 15L, 15C, or 15R so that the combination of the stopped symbols on the payline is won. The position shift detection circuit 71 detects the position change in the above case.

The hopper 66 is arranged inside of the cabinet 12. The hopper 66 pays a payout with coins through the coin payout opening 28 to the coin tray 29 based on the control signal from the main CPU 41. The coin detection portion 67 may be arranged inside of the coin payout opening 28. If the coin detection detects that predetermined coins are paid through the coin payout opening 28, the coin detection portion will output the signal to the main CPU 41.

The graphic board 68 controls the display image displayed on the upper image display panel 30 and the lower image display panel 16 based on the control signal from the main CPU 41. The player's credit count, stored in the RAM 43, may be displayed of the credit count display portion 18. The payout number may be displayed on the payout count display portions 19. Here, in the bonus game, the graphic board 68 controls bonus game image (see FIG. 15 and FIG. 16) so as to display the bonus game image. The graphic board 68 may include VDP (Video Display Processor) and a video RAM. The image data generated by the VDP is temporarily stored in the video RAM. The VDP generates the image data based on the control signal from the main CPU 41. The data used when the image data is generated by the VDP may be included in the game program.

The bill verifier 22 verifies the bill or the ticket with the barcode. The bill verifier 22 receives the qualified bill or the ticket into the cabinet 12. When qualified bill is inserted, the bill verifier 22 will output the signal to the main CPU 41 based on the value thereof. When qualified ticket is inserted, the bill verifier 22 will output to the main CPU 41 based on the number of coins printed thereon.

A control panel 20, the coin verifier 21S, and the coin counter 21C are directly or indirectly connected to the door PCB 80. Here, a cold cathode fluorescent lamp 81 may be connected to the door PCB 80. A spin switch 23S, a change switch 248, a cash-out switch 25S, a 1-bet switch 26S, and a max-bet switch 27S are arranged on the control panel 20. The spin switch 23S is associated with the spin button 23. The change switch 24S is associated with the change button 24. The cash-out switch 258 is associated with the cash-out button 25. The 1-bet switch 26S is associated with the 1-bet button 26. The max-bet switch 27S is associated with the max-bet button 27. Each of switches may output the input signal to the main CPU 41 when the button corresponding thereof is operated by the player.

The coin counter 21C is arranged inside of the coin insertion slot 21. The coin counter 21C verifies the coin inserted from the coin insertion slot 21 by the player. Any fake coins may be discharged through the coin payout opening 28. If a qualified coin is detected, the coin counter 21C will output the signal to the main CPU 41.

The coin verifier 21S may be controlled based on the control signal from the main CPU 41. The coin verifier 21S sorts the qualified coins into a cash box (not shown) or the hopper 66. The cash box is arranged inside of the slot machine 1. Here, the lower image display panel 16 may be a LED. A cold cathode fluorescent lamp 81 may be arranged back side of the lower image display panel 16 and the upper image display panel 30. Here, a cold cathode fluorescent lamp 81 functions as a back light and turns on based on the control signal from the main CPU 41.

The control system of the server 2 in the first embodiment will be described with reference to FIG. 1. FIG. 1 is a block diagram schematically showing the control system of the server 2 of the first embodiment.

As shown in FIG. 1, the control system of the server 2 may be constructed from a CPU 91, a ROM 92, a RAM 93, a graphic board 94, and server communication interface 95. The CPU 91, the ROM 92, the RAM 93, and the graphic board 94 are interconnected via internal bus.

The ROM 92 may be constructed from a memory device such as the flash memory (for example). The preliminary data such as the jackpot accumulation process program and communication process program executed in the slot machine 1 may be stored in the ROM 92. The programs can be executed by the CPU 91.

The data and the programs used when the CPU 91 runs may be stored in the RAM 93. The first jackpot value storage area 96, the second jackpot value storage area 97, and the third jackpot value storage area 98 may be formed in the RAM 93. First jackpot value may be stored in the first jackpot value storage area 96. Second jackpot value may be stored in the second jackpot value storage area 97. Third jackpot value may be stored in the third jackpot value storage area 98. When the CPU 91 receives bet information and jackpot identification information, the CPU 91 reads the jackpot value from the jackpot value storage area corresponding to jackpot identification information, adds five percent (for example) of the bet count to the jackpot value which is read. Here, the portion of the bet count is variable. And then, added jackpot value may be re-stored in the same jackpot value storage area of the RAM 93.

The graphic board 94 controls the main display 5 to display predetermined images based on the control signal form the CPU 91. Concretely, the graphic board 94 controls so as to display fish images. The fish images correspond to jackpot value accumulated from the staring value until now for the first jackpot, the second jackpot, and the third jackpot (see FIG. 12). The graphic board 94 may include VDP (Video Display Processor) and a video RAM. The image data generated by the VDP may be temporarily stored in the video RAM. The VDP generates the image data based on the control signal from the main CPU 91. The data used when the image data is generated by the VDP may be included in the game program.

The winning combination and payout number thereof, in the base game using the reels 15L, 15C, and 15R in the slot machine 1 of the first embodiment, will be described with reference to FIG. 6. FIG. 6 shows the payout table which indicates the winning combination, the probability thereof, and the payout number thereof, in the game using the reels 15L, 15C, and 15R. FIG. 6 indicates the payout number in the case where the bet count is “1”. If the bet count is “1”, the payout number shown in FIG. 6 will be added to the credit count. If the bet count is more than “1”, the payout number shown in FIG. 6 will be multiplied by the bet count, and multiplied number will be added to the credit count.

FIG. 6 shows winning probabilities for each of the winning combination with 88% payout ratio in other than the bonus game. The winning probabilities shown in FIG. 6 indicate the probabilities in which each of winning combinations is realized when each of the code numbers corresponding to reels 15L, 15C, and 15R is determined based on three random number values with the use of the symbol weighing data table. That is, each of the winning combinations does not corresponding random number value.

For example, in FIG. 6, the winning probability for the bonus game trigger may be 0.5%. If the bonus trigger is realized, three “RED7” symbols will be stopped and displayed on the payout line and the payout number “10” will be provided, in addition, the bonus game will be occurred.

The winning probability for “BLUE7” may be 0.8%. If the winning combination “BLUE7” is realized, three “BLUE7” symbols may be stopped and displayed on the payline and the payout number “10” per one bet will be provided. The winning probability for “BELL” may be 1.1%. If the winning combination “BELL” is realized, three “BELL” symbols may be stopped and displayed on the payline and the payout number “8” per one bet will be provided. In the same way mentioned above, each of the relations between the winning probability and the payout number respectively corresponds to each of the winning combinations shown in FIG. 6. Here, the combination not associated with any of the winning combinations shown in FIG. 6 is realized, the game is lost. If the game is lost, none of the payout number will be paid. Also, the relation between the winning probability and the payout number may be variable.

The bonus game lottery table will be described with reference to FIG. 7. The bonus game lottery table may be used when the payout is determined in the bonus game in the slot machine 1 of the first embodiment. FIG. 7 shows the bonus game lottery table of the first embodiment. As shown in FIG. 7, predetermined ranges of random number value correspond to the payout in the bonus game lottery table. For example, the range of random number value “0” to “2000” may be used in the payout lottery of the bonus game. The random number value may be sampled by the main CPU 41. Here, the range of random number value used in the payout lottery is variable.

Concretely, the range of the random number value “0” corresponds to the winning of the first jackpot. The range of the random number value “1” to “5” corresponds to the winning of the second jackpot. The range of the random number value “6” to “30” corresponds to the winning of the third jackpot. The range of the random number value “31” to “500” corresponds to the payout number “1000 credits”. The range of the random number value “501” to “1200” corresponds to the payout number “500 credits”. The range of the random number value “1201” to “2000” corresponds to the payout number “100 credits”. When any of the jackpots is won, the CPU 41 will provide credit count corresponding to winning jackpot value. If the payout number is won, the credit corresponding thereto will be provided. Here, the bonus game lottery table may be constructed so that more than one jackpot (for example, two jackpots) is won at once. In this case, some range of the random number value may correspond to the winning of the second jackpot and the third jackpot. For example, the range of the random number value “10” to “20” may correspond to the winning of the second jackpot and the third jackpot.

An accumulation object selection table will be described with reference to FIG. 8. The accumulation object selection table may be used when the jackpot to be accumulated is selected in response to player's bet in the slot machine 1 of the first embodiment. FIG. 8 shows the accumulation object selection table of the first embodiment. As shown in FIG. 8, the sequence of the selection for three jackpots to be accumulated credit count is set in the accumulation object selection table. The accumulation object selection table may include pattern A and pattern B. Here, the number of pattern is variable. Either the pattern A or the pattern B table will be selected when the power of the slot machine 1 will be ON.

For example, in the pattern A, the jackpot to be accumulated may be selected in such a way that “the first jackpot”→“the second jackpot”→“the second jackpot”→“the third jackpot”→“the third jackpot”→“the first jackpot”→“the second jackpot”→“the third jackpot”→ . . . . Also, in the pattern B, the jackpot to be accumulated may be selected in such a way that “the third jackpot”→“the second jackpot”→“the first jackpot”→“the first jackpot”→“the second jackpot”→“the third jackpot”→“the second jackpot”→“the first jackpot”→ . . . . The CPU 91 reads the jackpot value from the jackpot value storage area (among the first jackpot value storage area to the third jackpot value storage area) corresponding to the selected jackpot based on the accumulation object selection table, adds five percent (for example) of the bet count to the jackpot value which is read. Here, more than one jackpot (for example, two jackpots) may be selected at once. In this case, in the pattern A, the jackpot to be accumulated may be selected in such a way that “the first jackpot”→“the second jackpot and the third jackpot”→“the first jackpot and the second jackpot”→ . . . . Here, the portion of the bet count is variable. And then, added jackpot value may be re-stored in the same jackpot value storage area of the RAM 93.

A main control program, which is executed in the slot machine 1 of the first embodiment, will be described in detail with reference to the drawing. FIG. 9 is a flowchart of the main control program. Concerning the slot machine 1, the memory card 53 is connected to the card slot 53S of the gaming board 50, and the GAL 54 may be directly or indirectly connected to the IC socket 54S.

When the power switch of the power source unit 45 is ON, the mother board 40 and the gaming board 50 are booted-up respectively, and the verification read process (S1) is executed. In the verification read process, the mother board 40 and the gaming board 50 execute separately processes in parallel. In the gaming board 50, the CPU 51 reads the preliminary verification program from the boot ROM 52, and verifies that the verification program is not falsified before the verification program is taken to the mother board 40. In the mother board 40, the main CPU 41 executes BIOS stored in the ROM 42, and checks and initializes various peripheral devices. Here, BIOS may be compressed, then, BIOS is decompressed. BIOS may be copied to the RAM 43.

The CPU 41 reads the verification program stored in the ROM 55, and verifies that game program and the like is not falsified. Here, the game program and the like is stored in the memory card 53 which is inserted to the card slot 53S. After the verification process is ended, the main CPU 41 writes program to the RAM 43, and acquires payout data and country ID. After the process mentioned above is finished, the main CPU 41 finishes the verification read process.

In S2, the main CPU 41 selects either the pattern A or the pattern B from the accumulation object selection table (see FIG. 8). Here, in each of the pattern, the sequence of the selection for three jackpots to be accumulated credit count may be set.

In S3, the main CPU 41 reads the game program and the like which was verified in S1 from the RAM 43, and executes the main game process. The game in the first embodiment of the slot machine 1 is executed by executing the main game process. The main game process is executed repeatedly during the electronic power source being supplied.

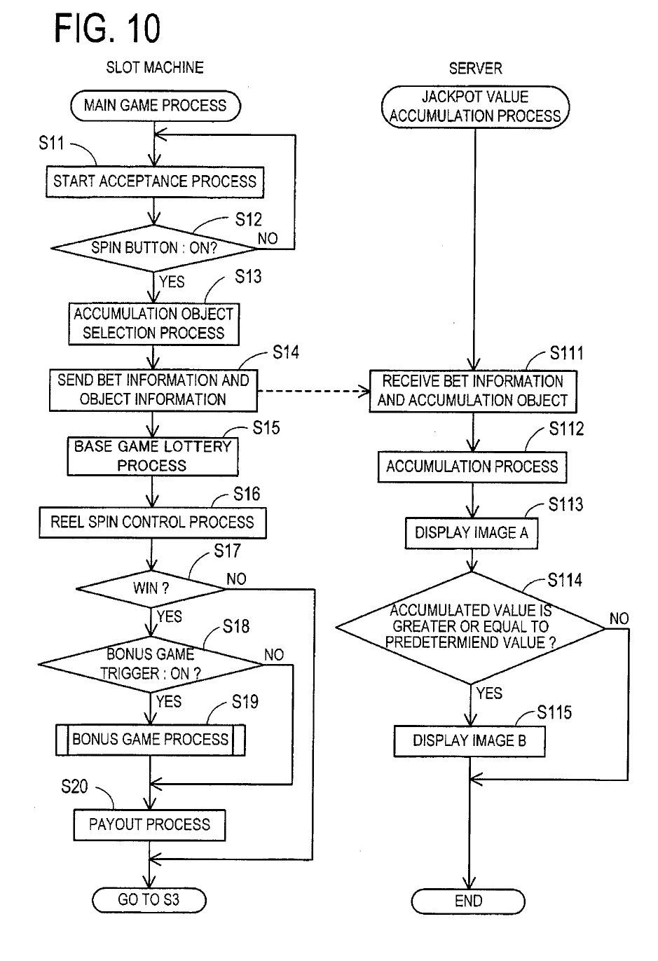

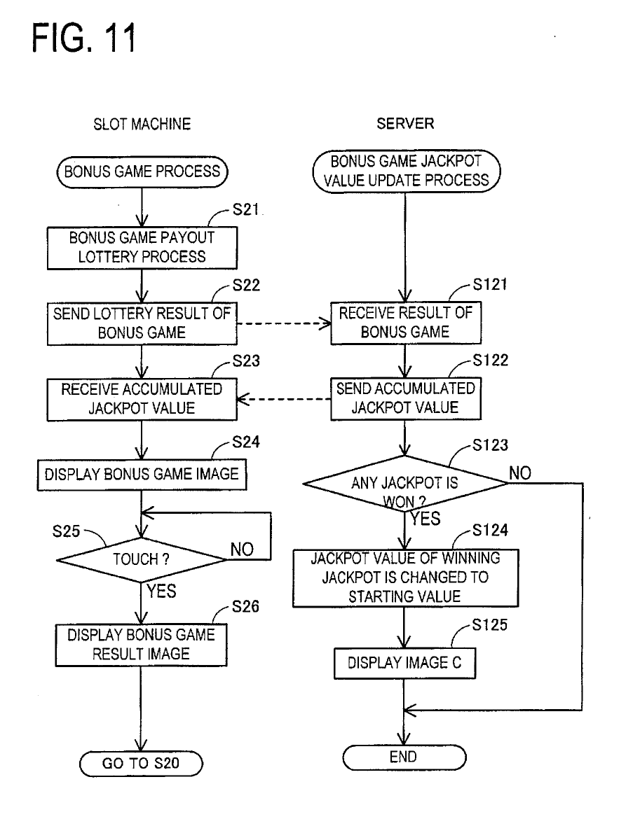

The sub process of the main game process in S2 and a jackpot value accumulation process executed in the server 2 will be described with reference to FIG. 10. The jackpot value accumulation process may be executed in parallel with the sub process of the main game process. FIG. 10 and FIG. 11 are flowcharts of the main game process program in the slot machine 1 and the jackpot value accumulation process program in the server 2. The programs which are executed as methods of the flowcharts shown in FIG. 10 and FIG. 11 may be stored in the ROM 42, the ROM 92, the RAM 43, or the RAM 93 in the slot machine 1 and the server 2, and executed by the main CPU 41 or the CPU 91.

The main game process executed by the slot machine 1 will be described with reference to FIG. 10. In S11, the main CPU 41 performs predetermined initial setting, and then, executes the start acceptance process. The coin is inserted and the bet count for the payline is set during the start acceptance process. The coin or the credit may be used when the bet operation is conducted. The bet operation with the use of the 1-bet button 26 or the max-bet button 27 may be conducted by the player. The coin may be inserted from the coin insertion slot 21 by the player, or the bet operation may be conducted by the player with the use of the 1-bet button 16 or the max-bet button 17. The main CPU 41 detects the number of inserted coin and the bet operation of 1-bet button 26 or the max-bet button 27.

In S12, the main CPU 41 determines whether or not the spin button 23 is operated. It is determined whether or not the spin button 23 is operated based on that whether or not the input signal from the spin switch 23S is received. If it is determined that the spin button 23 is not operated (S12:NO), the procedure will be returned to the start acceptance process (S11) again. In that time, some instructions such as changing the bet count are available. On the other hand, if it is determined that the spin button 23 is operated (S12:YES), the bet count, which is set for the payline L based on the operation of 1-bet button 26 or max-bet button 27, will be subtract from credit count in which the player owns. And, the bet count will be stored in RAM 43 as the bet information.

In S13, the main CPU 41 executes the accumulation object selection process. The object jackpot to be accumulated in current game may be determined in the accumulation object selection process by lottery. Concretely, the main CPU 41 determined the sequence of selection for the jackpot to be accumulated with the use of the selected pattern (namely, the pattern A or the pattern B). Here, either the pattern A or the pattern B table will be selected when the power of the slot machine 1 will be ON. After that, the main CPU 41 figures up the number of executed games since the slot machine 1 is ON, and the jackpot to be accumulated will be selected any of the first jackpot, the second jackpot, or the third jackpot in current game. Accordingly, the jackpot to be accumulated may be changed in accordance with predetermined rule based on the selected pattern. Here, the pattern will be selected when the power of the slot machine 1 will be ON.

In S14, the bet information and the jackpot identification information may be sent to the server 2. The bet information indicates the bet value which is input in S11. The jackpot identification information indicates the jackpot selected in the accumulation object selection process of S13. The server 2 may accumulate the jackpot value based on received information (which will be described later).

In S15, the main CPU 41 executes the base game process. The base game process may be executed with the use of the reels 15L, 15C, and 15R. Concretely, the main CPU 41 executes random number value generation program included in lottery program stored in the RAM 43, at result, each of the random number values of each reel 15L, 15C, and 15R is generated from the predetermined range of the random number value (“0” to “255”, for example). The code numbers of the each reel 15L, 15C, and 15R (see FIG. 4) may be determined based on the random number value and the symbol weighting table. Each of the symbol weighting tables corresponds to the payout ratio setting data. The procedure will be shifted to S16 after the code numbers of each reel 15L, 15C, and 15R are stored in the RAM 43. Here, each of the code number of each of the reels 15L, 15C, and 15R corresponds to each of the code numbers of symbols to be stopped and displayed on the payline. Accordingly, the main CPU 41 determines the combination of symbols in current game by determining each of the code numbers of each of the reels 15L, 15C, and 15R. For example, if it is determined that the code number for the reel 15L is “00”, the code number for the reel 15C is “00”, and the code number for the reel 15R is “00”, the winning combination “RED7” will be realized. Herewith, the main CPU 41 conducts the lottery for winning combination (see FIG. 6) by determined the code numbers for each reels 15L, 15C, and 15R.

In S16, the main CPU 41 executes the part of the reel rotation control process. In the reel spin control process, each spinning reels 15L, 15C, and 15R will be stopped so that the symbols corresponding to determined combination of symbols in the base game lottery process (S51) are stopped and displayed on the payline L. The reel spin control process is executed by the main CPU 41 and the sub CPU 61.

Concretely, in the reel spin control process (S16), the main CPU 41 transmits the start signal to the sub CPU 61. The start signal instructs to start the reel spin. When the sub CPU 61 receives the start signal, the sub CPU 61 executes the reel spin process. That is, each stepping motors 701, 70C, and 70R are driven by the motor drive circuit 62 and the driver 64. At result, each of the reels 15L, 15C, and 15R will start to spin. After the start signal is transmitted, the main CPU 41 determines a production pattern (for example, the image display on the lower image display panel 16 and output sound from the loudspeaker 31), and the determined production pattern will be conducted. When it becomes predetermined point is time in which the reels 15L, 15C, and 15R are to be stopped, the main CPU 41 will transmit the code numbers of the reels stored in the RAM 43 to the sub CPU 61. The sub CPU 61 executes the reel stop process based on the code numbers of the reels. Accordingly, the symbols corresponding to the random result may be stopped and displayed in the each of the display windows 17L, 17C, and 17R.

In S17, the main CPU 41 determines whether or not any winning combination is won in the base game of the slot machine 1. If it is determined that any winning combination shown in FIG. 6 is realized (S17:YES), the procedure will be shifted to S18. On the other hand, if it is determined that none of winning combination is not realized (S17:NO), the main game process will be finished.

In S18, the main CPU 41 determines whether or not the bonus game trigger is realized. Concretely, if it is determined that the winning combination of symbols “RED7” is stopped and displayed on the payline, it will be determined that the bonus game trigger is realized.

If it is determined that the bonus trigger is realized (S18:YES), the bonus game process (S19, which will be described later) will be executed and then the payout obtained in the base game and the bonus game will be provided to the player (S20). Here, if any of the jackpots is won, the payout number corresponding to the jackpot value associated with the jackpot which is won will be provided. In this time, if the cashout button 25 is pressed, the coin corresponding to the credit count (for example, one credit is equal to one coin) may be paid or the ticket (with the barcode) may be printed. Here, more than one jackpot (for example, two jackpots) may be selected at once.

On the other hand, if it is determined that the bonus game trigger is not realized (S18:NO), the payout number obtained in the base game will be provided to the player (S20). After that, the procedure will be returned to the S2 and the main game process will be executed again.

The jackpot value accumulation process executed in the server 2 will be described with reference to FIG. 10. In S11, the CPU 91 receives the bet information and the jackpot identification information from the connected slot machine 1 via the network 4. The bet information indicates the bet value input by the player. The jackpot identification information indicates the jackpot which is selected.

In S112, the CPU 91 executes the jackpot value accumulation process. Concretely, the CPU 91 reads the jackpot value from the selected jackpot value storage area. That is, if the first jackpot is selected, the CPU 91 reads the jackpot value from the first jackpot value storage area 96. If the second jackpot is selected, the CPU 91 reads from the second jackpot value storage area 97. If the third jackpot is selected, the CPU 91 reads from the third jackpot value storage area 98. After that, adds five percent (for example) of the bet count to the jackpot value which is read. Here, the portion of the bet count is variable. And then, added jackpot value may be re-stored in the same jackpot value storage area of RAM 93.

In S113, the CPU 91 controls the main display 5 to display image A. The image A indicates that the fish image corresponding to selected jackpot (among three fish images which move in the jackpot value display image 101) is fed. FIG. 12 shows an example of the jackpot value display image 101 displayed on the main display 5 of the first embodiment.

The server 2 controls the main display 5 to display the jackpot value display image 101 on the main display 5 regardless of each the condition of connected slot machines 1 (namely, the slot machines 1 are operated or not). As shown in FIG. 12, the jackpot value display image 101 may include a pond image 102 and three fish images (first fish image 103, second fish image 102, and third fish image 103). Three fish images are displayed so as to look like swimming in the pond image 102. The characters “JP1” may be displayed under the first fish image 103, as shown in FIG. 12. The character “JP2” may be displayed under the second fish image 104 as shown in FIG. 12. The character “JP3” may be displayed under the third fish image 105 as shown in FIG. 12. Here, each of the fish image (the first fish image 103 to the third fish image 105) can indirectly inform the jackpot value accumulated from the stating value until now. Each of the fish images may be character image. Here, image is variable. As shown in FIG. 13, the image used in the first fish image to the third fish image may include three kinds of fish image. Each of three kinds of fish image corresponds to each of the ranges of the jackpot value. Each of the ranges are different each other. For example, if the jackpot value which is accumulated from starting value lies in a range of “0” to “1000” credits, a small-size image will be displayed. If the jackpot value accumulated from the starting value lies in a range of “1001” to “2000” credits, a medium-size fish image may be displayed. The medium-size fish image is larger than the small-size fish image. If the jackpot value accumulated from the starting value is more than “2000” credits, a large-size fish image may be displayed. The large-size fish image is larger than the middle-size fish image. Accordingly, the player can easily recognize which range the jackpot value lies therein by looking the fish image displayed on the main display 5. For example, the player can recognize that the accumulated jackpot value of the first jackpot is more than 2000 credits, the accumulated jackpot value of the second jackpot lies in the range of “1001” to “2000” credits, and the accumulated jackpot value of the third jackpot lies in the range of the “0” to “1000” credits, by looking the jackpot value display image 101 shown in FIG. 12.

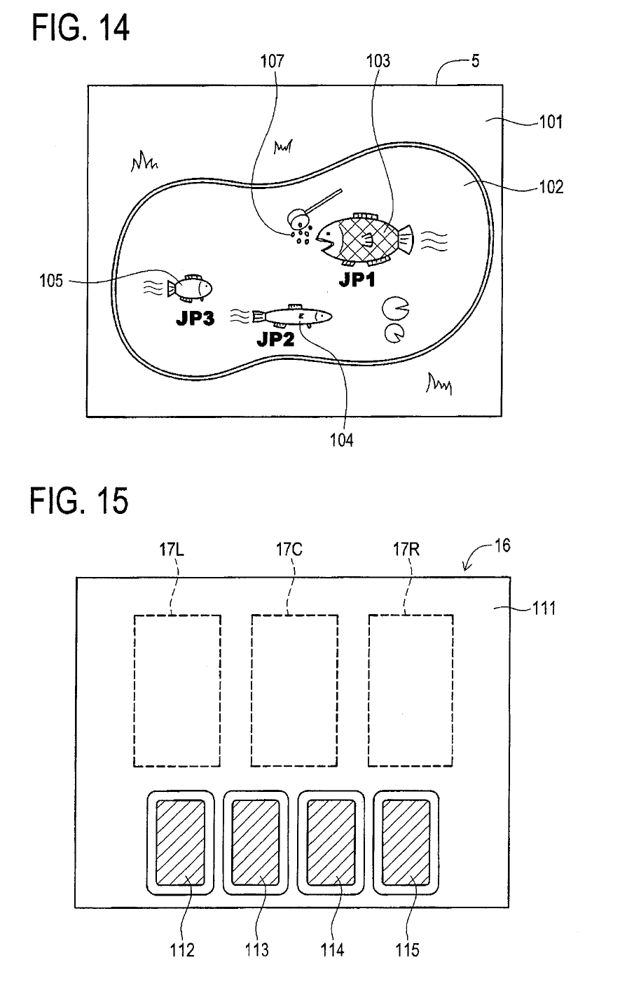

In S113, as shown in FIG. 14, the image A which indicates that the fish image corresponding to the selected jackpot (among the first fish image 103 to the third fish image 105 which move in the jackpot value display image 101) may be displayed look like being fed bait and eating the bait. Accordingly, the jackpot to be accumulated will be informed to the player in response to the player's bet in current game.

In S114, the CPU 91 determines whether or not the jackpot value accumulated in the accumulation process of S112 reaches predetermined value (for example, in the first embodiment, “1001” credits or “2001” credit). If it is determined that the accumulated jackpot value reaches the predetermined value (S114:YES), the image B will be displayed on the main display 5 (S115). In the image B, the fish image (among the first fish image 103 to the third fish image 105) is changed to larger fish image. For example, if accumulated jackpot value reaches “1001” credits, the fish image corresponding to the accumulated jackpot value (among the first fish image 103 to the third fish image 105) will be changed from the small-size fish image to the medium-size fish image. If accumulated jackpot value reaches “2001” credits, the fish image corresponding to the accumulated jackpot value (among the first fish image 103 to the third fish image 105) will be changed from the medium-size fish image to the large-size fish image. On the other hand, if it is determined that the accumulated jackpot value does not reach the predetermined value (S114:NO), the jackpot value accumulation process will be finished.

The sub process of the bonus game process of S19 and a bonus frame jackpot value update process executed in the server 2 will be described with reference to FIG. 11. The bonus game jackpot value update process may be executed in parallel with the bonus game process. FIG. 11 is flowcharts of the bonus game process program in the slot machine 1 and the bonus game jackpot value update process program in the server 2.

The bonus game process executed in the slot machine 1 will be described with reference to FIG. 11. In S21, the main CPU 41 conducts the lottery for the payout to be provided to the player. Concretely, the main CPU 41 executes the random number value generation program included in the lottery program stored in the RAM 43. The random number value will be selected among “0” to “2000”. The payout to be provided to the player may be determined among “winning of the first jackpot”, “winning of the second jackpot”, “winning of the third jackpot”, “1000 credits payout number”, “500 credits payout number”, or “100 credits payout number” with the use of the bonus game lottery table.

In S22, the payout information related to the payout to be provided to the player in the bonus game will be sent to the serves 2 based on the lottery result of the lottery process in S21. The server 2 may update the jackpot value based on received information (which will be described later).

In S23, the main CPU 41 receives the current jackpot values for each of the jackpots from the server 2. If any of the jackpot is won, the main CPU 41 calculates the payout number based on the jackpot values and the result of S21. In S24, the main CPU 41 displays the bonus game image 111 on the lower image display panel 16. FIG. 15 shows the bonus game image 111 displayed on the lower image display panel 11 in the slot machine 1 of the first embodiment. As shown in FIG. 15, the bonus game image 111 may be constructed from four card images 112 to 115 displayed on the lower portion of the main display 5. The card images 112 to 115 may be displayed without overlapping with display windows 17L, 17C, and 17R, so that the player can look the card images 112 to 115 easily.

In S25, it is determined whether or not any of the card images 112 to 115 on the bonus game image 111 is touched by the player based on operation information from the touch panel 11. If it is determined that the player does not touch any of the card image (S25:NO), the CPU 41 will wait until that the player touches. On the other hand, if it is determined that the player touches any of the card image (S25:YES), the procedure will be shifted to S26.

In S26, the main CPU 41 controls the main display 5 to display the bonus game result image. Here, the bonus game result image may include the image in which selected card image (among four displayed card images 112 to 115) is changed to reversed image. Accordingly, the payout in the bonus game can be displayed and informed to the player. After the bonus game result image is displayed, the procedure will be shifted to the payout process of S20 and the payout number obtained in the bonus game will be provided. FIG. 16 shows an example of the bonus game image 111 in case where “winning of the third jackpot” is selected as the payout and the card image 114 is selected by the player in the bonus game payout lottery process. As shown in FIG. 16, if the player selects the card image 114 (among four card images 112 to 114 displayed on the bonus game image 111) by touching thereof, the card image 114 will be changed to reversed image. The reversed image indicates the character 116 “JP3” informing the payout “winning of the third jackpot”. Here, if the card image 112, the card image 113, or the card image 115 is selected by the player, selected card image will be changed to the reversed image. The reverse image indicates the character 116 “JP3” informing the payout “winning of the third jackpot”. Herewith, the player can recognize the payout obtained in the current bonus game.

The bonus game jackpot value update process executed in the server 2 will be described with reference to FIG. 11. In S121, the CPU 91 receives information related to the result of the bonus game from the connected slot machine 1 via the network 4.

In S122, the CPU 91 may send the jackpot valued accumulated until now (the first jackpot value to the third jackpot value) to the slot machine 1 in which the result of the bonus game is sent.

In S123, the CPU 91 determines which jackpot is won (among the first jackpot, the second jackpot, or the third jackpot) based on the result of the bonus game received in the S121.

If it is determined that any jackpot is won (S123:YES), the jackpot value of winning jackpot will be updated to the starting value (S124). Concretely, the CPU 91 reads the accumulated jackpot value from the jackpot value storage area corresponding to the winning jackpot. That is, if the first jackpot is won, the CPU 91 will read from the first jackpot value storage area. If the second jackpot is won, the CPU 91 will read from the second jackpot value storage area. If the third jackpot is won, the CPU 91 will read from the third jackpot value storage area. And then, accumulated jackpot value which is read will be changed to the predetermined starting value. (for example, “2000” credits for the first jackpot, “1000” credits for the second jackpot, “500” credits for the third jackpot), and then changed jackpot value will be stored in the RAM 93.

In S125, the CPU 91 controls the main display 5 to display image C. In the image C, the fish image (the first fish image 103 to the third fish image 105) is changed to the small-size fish image corresponding to the jackpot in which the jackpot value thereof is changed to the starting value. Here, the small-size fish image indicates pre-growth fish. For example, the jackpot, in which the jackpot value accumulated from staring value lies in the range of “1001” to “2000”, is won, fish image corresponding thereto (among the first fish image 103 to the third fish image 105) will be changed from the medium-size fish image to the small-size fish image. Also, the jackpot, in which the jackpot value accumulated from staring value is more than “2000”, is won, fish image corresponding thereto (among the first fish image 103 to the third fish image 105) will be changed from the large-size fish image to the small-size fish image. Further, the jackpot, in which the jackpot value accumulated from staring value is less than “1000”, is won, fish image corresponding thereto (among the first fish image 103 to the third fish image 105) will not be changed. On the other hand, if it is determined that none of jackpot is won in S123 (S123:NO), the bonus game jackpot update process will be finished.

As mentioned above, in the slot machine 1 and game system 3 of the first embodiment, the jackpot to be accumulated the portion of the bet count is selected among the first jackpot to the third jackpot in predetermined order (S13), selected jackpot will be accumulated the portion of credit count (S112). Plural jackpots may give the player great expectation of winning the jackpot. Also, incrementation patterns of each jackpot may be different each other. Herewith, the slot machine having the progressive bonus may conduct various production and demonstration. Further, in the slot machine 1 and the game system 3 of the first embodiment, the jackpot value display image 101 may be displayed on the main display 5. The first fish image 103 to the third fish image 105 may move in the jackpot value display image 101. The fish images correspond to the jackpot value accumulated from the starting value until now, so the fish images can inform each jackpot value of the each jackpot ambiguously. At result, the player may estimate the jackpot value, so it allows that the interest of the game is enhanced. The fish image can be informed to the player easily compared to when the jackpot value is informed in characters. That is, the difference of each of the jackpot value can be informed easily for the player. Herewith, it may give the player an expectation that higher jackpot value may be won soon.

### Second Embodiment

Next, a game system of the second embodiment embodying one or more aspects of the invention will be described with reference to FIG. 17. The reference characters of FIG. 17, which are the same as the reference characters of FIG. 1 to 16, designate the same parts.

A structure of the game system of the second embodiment is almost same as in the first embodiment of the game system 3. A control process of the game system in the second embodiment is almost same as the game system 3 of the first embodiment. Here, in the game system 3 of the first embodiment, each of the first fish image 103 to the third fish image 105 displayed on the jackpot display image 101 corresponds to the jackpot value accumulated from the starting value of the first jackpot value to the third jackpot value (namely, each of the fish images corresponds to the accumulated jackpot value not including the starting value), on the other hand, in the game system of the second embodiment, each of the first fish image 103 to the third fish image 105 displayed on the jackpot display image 101 corresponds to the accumulated jackpot value including the starting value of the first jackpot value to the third jackpot value.

FIG. 17 shows the first fish image 103 to the third fish image 105. Each of the fish image will be displayed on the jackpot value display image 101 (see FIG. 12). Each of the fish images corresponds to each of the ranges of the jackpot value (including the starting value). Each of the ranges are different each other. For example, if the jackpot value (including the staring value) lies in a range of “0” to “2000” credits, a small-size image will be displayed. If the jackpot value (including the starting value) lies in a range of “2001” to “5000” credits, a medium-size fish image may be displayed. The medium-size fish image is larger than the small-size fish image. If the jackpot value (including the starting value) is more than “5000” credits, a large-size fish image may be displayed. The large-size fish image is larger than the middle-size fish image. Accordingly, the player can easily recognize which range the jackpot value including the starting value lies therein by looking the fish image displayed on the main display 5. In the game system of the second embodiment, in the jackpot value accumulation process (FIG. 10) executed in the server 2, in S114, it is determined whether or not the accumulated jackpot value including the starting value reaches “2001” credits or “5001” credits. In S115, the image B may be displayed based on the result of S114. Here, in the image B, any of the fish image (the first fish image 103 to the third fish image 105) corresponding to the jackpot to be accumulated may be changed (S115).

As mentioned above, in the slot machine 1 and the game system 3 of the second embodiment, the jackpot value display image 101 may be displayed on the main display 5. The first fish image 103 to the third fish image 105 may move in the jackpot value display image 101. The fish images correspond to the jackpot values including the starting value. It allows that the interest of the game for the player is enhanced.

### Third Embodiment

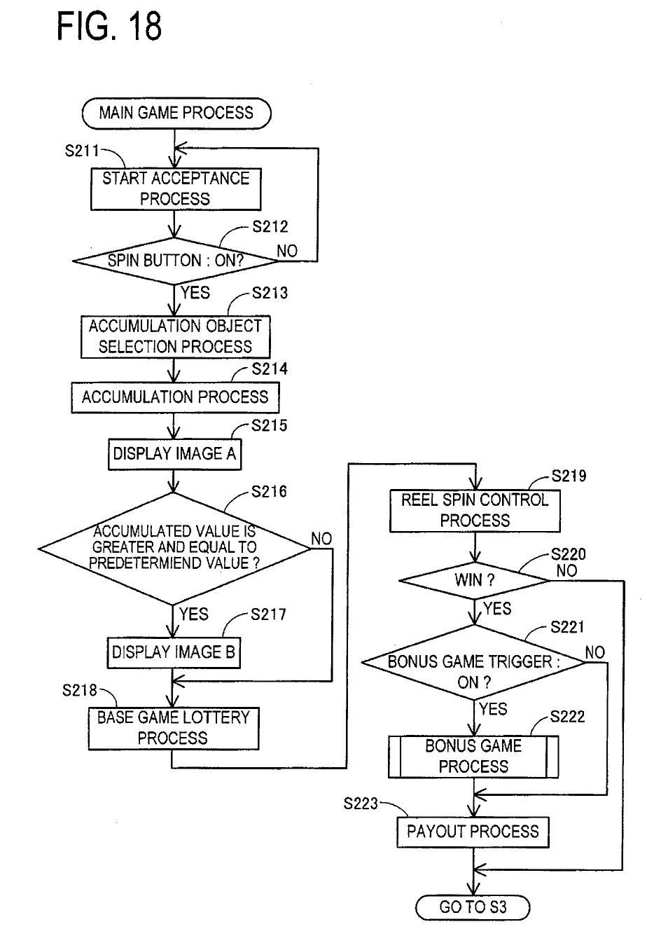

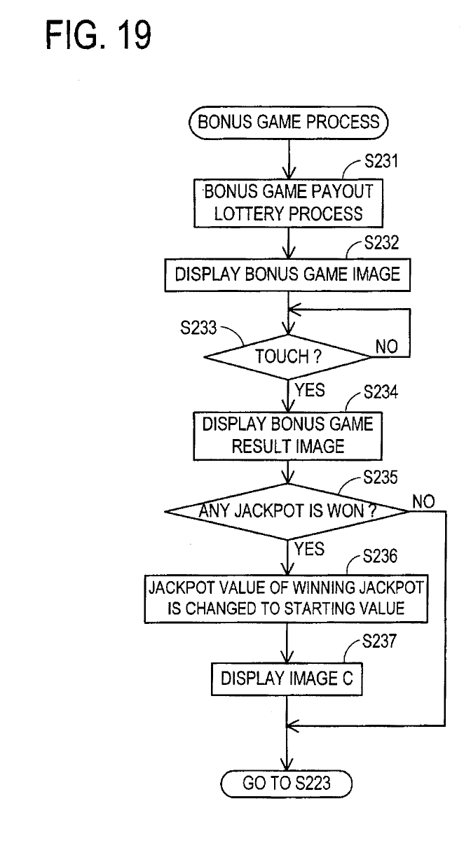

Next, a slot machine of the third embodiment embodying one or more aspects of the invention will be described with reference to FIG. 18 and FIG. 19. The reference characters of FIG. 18 and FIG. 19, which are the same as the reference characters of FIG. 1 to 16, designate the same parts.

A structure of the slot machine of the third embodiment is almost same as in the first embodiment of the slot machine 1. Various control process of the slot machine in the third embodiment is almost same as the slot machine of the first embodiment. Here, in the slot machine 1 of the first embodiment, storages (which store each of the jackpot value) and a display (which displays the jackpot value display image 101) are included in the server 2 and the jackpot accumulation process and the jackpot value display process are executed in the server 2. On the other hand, in the slot machine 1 of the third embodiment, the storages (which store each of the jackpot value) and a display (which displays the jackpot value display image 101) are included in the slot machine 1 and the jackpot accumulation process and the jackpot value display process are executed in the slot machine 1 without the server 2.

A sub process of a main game process in the slot machine of the third embodiment will be described in detail with reference to FIG. 18. FIG. 18 is a flowchart of the main game program.

Here, the process of S211 to S213 and S218 to S223 are the same as the process S11 to S13 and S15 to S20 in the main game process of the first embodiment (FIG. 10) as mentioned above, so this explanation will be omitted. Here, in the slot machine of the third embodiment, the first jackpot value storage area 96 to the third jackpot value storage area 98 will be arranged in each of the slot machines.

In S214, the main CPU 41 executes the jackpot value accumulation process. Concretely, the main CPU 41 reads the jackpot value from the selected jackpot value storage area based on the result of the accumulation object selection process of S213. That is, if the first jackpot is selected, the main CPU 41 reads the jackpot value from the first jackpot value storage area 96. If the second jackpot is selected, the main CPU 41 reads from the second jackpot value storage area 97. If the third jackpot is selected, the main CPU 41 reads from the third jackpot value storage area 98. After that, adds five percent (for example) of the bet count to the jackpot value which is read. Here, the portion of the bet count is variable. And then, added jackpot value may be re-stored in the same jackpot value storage area of the RAM 43.

In S215, the main CPU 41 controls the upper image display panel 30 to display image A. Here, the image A indicates that the fish image corresponding to the selected jackpot (among the first fish image 103 to the third fish image 105 which move in the jackpot value display image 101) may be displayed look like being fed bait and eating the bait. The jackpot value display image 101 shown in FIG. 12 may be displayed on the upper image display panel 30 regardless of each the condition of connected slot machines 1 (namely, the slot machines 1 are operated or not). As mentioned above, the jackpot value display image 101 is explained with the use of FIG. 12 to FIG. 14, so this explanation will be omitted. In S215, as shown in FIG. 14, the image A which indicates that the fish image corresponding to the accumulated jackpot (among the first fish image 103 to the third fish image 105 which move in the jackpot value display image 101) in S214 may be displayed look like being fed bait and eating the bait. Accordingly, the jackpot to be accumulated will be informed to the player in response to the player's bet in current game.

In S216, the main CPU 41 determines whether or not the jackpot value accumulated in the accumulation process of S214 reaches predetermined value (for example, in the third embodiment, “1001” credits or “2001” credit). If it is determined that the jackpot value reaches the predetermined value (S216:YES), the image B will be displayed on the main display 5 (S217). In the image B, the fish image (the first fish image 103 to the third fish image 105) is changed to larger fish image. On the other hand, if it is determined that the accumulated jackpot value does not reach the predetermined value (S216:NO), the procedure will be shifted to S218 and the lottery process of the base game will be executed.

A sub process of a bonus game process of S222 in the slot machine of the third embodiment will be described in detail with reference to FIG. 19. FIG. 19 is a flowchart of the bonus game program in the slot machine of the third embodiment.

Here, the processes of S231 to S234 are the same as the process S21 and S24 to S27 in the bonus game process of the first embodiment (FIG. 11) as mentioned, so this explanation will be omitted. In S235, the main CPU 41 determined whether or not any of the first jackpot, the second jackpot, or the third jackpot is won.

If it is determined that any jackpot is won (S235:YES), the jackpot value of winning jackpot will be updated to the starting value (S236). Concretely, the main CPU 41 reads the accumulated jackpot value from the jackpot value storage area corresponding to the winning jackpot. That is, if the first jackpot is won, the main CPU 41 will read from the first jackpot value storage area 96. If the second jackpot is won, the main CPU 41 will read from the second jackpot value storage area 97. If the third jackpot is won, the main CPU 41 will read from the third jackpot value storage area 98. And then, accumulated jackpot value which is read will be changed to the predetermined starting value. (for example, “2000” credits for the first jackpot, “1000” credits for the second jackpot, “500” credits for the third jackpot), and then changed jackpot value will be stored in the RAM 43.

In S237, the main CPU 41 controls the upper display panel 30 to display image C. In the image C, the fish image (the first fish image 103 to the third fish image 105) is changed to the small-size fish image corresponding to the jackpot in which the jackpot value thereof is changed to the starting value. Here, the small-size fish image indicates pre-growth fish. On the other hand, if it is determined that none of jackpot is won (S123:NO), the bonus game jackpot update process will be finished.

As mentioned above, in the slot machine of the third embodiment, the jackpot to be accumulated the portion of the bet count is selected among the first jackpot to the third jackpot in the predetermined order (S213), and the selected jackpot will be accumulated the portion of bet count (S214). Plural jackpots may give the player great expectation of winning the jackpot. Also, incrementation patterns of each jackpot may be different each other. Herewith, the slot machine having the progressive bonus may conduct various production and demonstration. Further, in the slot machine of the third embodiment, the jackpot value display image 101 may be displayed on the main display 5. It allows that the interest of the game for the player may be enhanced.

Here, aspects of the present invention are not limited to the above embodiment and various changes and modification can be done within the scope of the present invention. For example, in one or more embodiments, the accumulation object selection process (which selects the jackpot to be accumulated the portion of the credit count in the predetermined order in S13) is executed in the slot machine 1. However, the invention is not so limited. For example, above process may be executed in the server 2. In this case, in S14, the slot machine 1 may send only the bet information to the server 2.

Also, in one or more embodiments, one jackpot is selected among the first jackpot to the third jackpot by lottery, and the portion of the bet count is accumulatively stored in one selected jackpot value storage area based on the pattern A or the pattern B. However, the invention is not so limited. For example, more than one jackpot may be selected based on the pattern, and the portion of the bet count may be accumulatively stored in selected jackpot value storage areas.

Also, in one or more embodiments, the bonus game is card-selection type game. However, the invention is not so limited. For example, the player may select the spot for fishing on the pond image 102 (see FIG. 12). If the jackpot is won in the bonus game payout lottery process, the fish image corresponding to winning jackpot may move like being hooked at the selected spot.

Also, in one or more embodiments, the fish images inform the jackpot value accumulated from the starting value until now or the accumulated jackpot value including staring value indirectly. However, the invention is not so limited. For example, the jackpot value accumulated from the starting value until now or the accumulated jackpot value including starting value may be concretely informed in characters. Further, the value may be informed both by the image and in the character.

Also, in one or more embodiments, the fish images changed among the small-size fish, the medium-size fish, and the large-size fish based on the jackpot value accumulated from the starting value or the jackpot value including the starting value. However, the invention is not so limited. For example, the values may be informed with the use of background image, the color thereof, motion of the image, or the like.

Also, in one or more embodiments, each of the jackpot value accumulated from the starting value is indirectly informed with the use of the kinds of the fish image. However, the invention is not so limited. For example, the ratio between the starting value and the current jackpot value (for example, in the case where the starting value is “1000” credits and the current jackpot value is “1500” credits, the ratio will be 150%) may be informed.

Also, in one or more embodiments, either the pattern A or the pattern B table will be selected when the power of the slot machine 1 will be ON. However, the invention is not so limited. For example, when any jackpot is won, either the pattern A or the pattern B table may be selected.

Also, in one or more embodiment, one or more aspects of the invention are applied to the progressive bonus executed in the slot machine having plural jackpot. However, the invention is not so limited. For example, one or more aspects of the invention may be applied to the progressive bonus game executed in poker game or bingo game

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a user interface configured to be input a bet value,
plural memory devices,
a processor programmed to:
(a) select one or more memory devices among the plural memory devices based on a predetermined rule, and accumulatively store a portion of the bet value in the one or more selected memory devices, and
(b) select one or more memory devices among the plural memory devices, and provide an outcome corresponding to one or more accumulated values stored in the one or more selected memory devices in response to a condition being satisfied.

2. The gaming machine according to claim 1, further comprising:
a display device configured to display images, each of the images being associated with the memory device and the accumulated value stored in the memory device.

3. A gaming method comprising:
(a) receiving a bet value,
(b) selecting one or more memory device among the plural memory devices based on a predetermined rule, and accumulatively storing a portion of the bet value in the one or more selected memory device, and
(c) when a condition is satisfied, selecting one or more memory device among the plural memory devices, and providing an outcome corresponding to one or more accumulated value stored in the one or more selected memory device.

4. The gaming method according to claim 3, further comprising:
displaying images, each of the images being associated with the memory device and the accumulated value stored in the memory device.

5. A game system comprising:
plural gaming machines, each of the gaming machines being configured to be input a bet value, and
a controller comprising:
plural memory devices, and
a processor programmed to:
(a) select one or more memory devices among the plural memory devices based on a predetermined rule, and accumulatively store a portion of the bet value in the one or more selected memory devices, and
(b) select one or more memory devices among the plural memory devices, and provide an outcome corresponding to one or more accumulated values stored in the one or more selected memory devices to a gaming machine among the plural gaming machines in response to the gaming machine satisfying a condition.

6. The game system according to claim 5, further comprising:
a display device configured to display images, each of the images being associated with the memory device and the accumulated value stored in the memory device.
